(19) United States
(12) Patent Application Publication
(10) Pub. No.: US 2012/0024859 A1
(43) Pub. Date: Feb. 2, 2012

(54) CONTAINER

(76) Inventors: Francesco Longoni, San Jose, CA (US); Mark E. Doutt, San Jose, CA (US)

(21) Appl. No.: 12/847,800

(22) Filed: Jul. 30, 2010

(51) Int. Cl. B65D 51/16; B29C 43/34

(52) U.S. Cl. 220/367.1; 264/242

(57) ABSTRACT

The embodiments herein describe a container constructed in a preformed manner, such that no assembly of the container is required before use. The container includes a lid portion that is coupled to the base portion through a hinged connection such that the entire container is singularly constructed from a single piece of material. A nested configuration is achieved such that the base and lid portions are shaped to receive the corresponding base and lid portions of a second container. Such nested configuration allows for multiple containers to be stored in a nested stack, thereby minimizing storage space. The container can be fabricated from various types of re-used material along the lines of molded fiber.

### TECHNICAL FIELD

The described embodiments relate generally to a container and more particularly to a portable and nestable container that is environmentally friendly.

### BACKGROUND OF THE INVENTION

Containers are used widely throughout many applications including the storage and transport of items. Containers are constructed in a wide array of sizes and shapes to contain a variety of items. Containers are constructed from various materials including plastics that provide the necessary support to contain an item, while still being economically feasible. However, as environmental concerns have increased over the years, the demand for a container that is constructed from an environmentally friendly material has risen. Furthermore, due to such environmental concerns, and in order to reduce the amount of consumption of materials, what is needed is a container that is adaptable for use in a wide variety of applications.

Therefore, what is needed is a container that is structurally stable enough for containing an item in a variety of applications and is also environmentally friendly.

### SUMMARY OF THE DESCRIBED EMBODIMENTS

A molded fiber container suitable for containing a food item includes a base having a plurality of ridges integrated with an interior surface of the base. When the food item is placed on at least some of the plurality of ridges, a gap is formed between the food item and the interior surface of the base, the gap assisting in thermally isolating the food item and allowing moisture expelled from the food item to be transported away from the food item. The container also includes a lid having a plurality of openings arranged in accordance with at least some of the plurality of ridges. The lid also including a moisture channeling feature integrally formed in the lid, the moisture channeling feature cooperating with at least some of the plurality of openings and the gap to provide a path by which at least some of the moisture expelled from the food item is transported out of the container and into an external environment.

A container includes at least a base portion. The base portion includes a a bottom surface that includes concentric ridges that provide structural support for the container and elevates a food item from the bottom surface forming a gap. The base portion also includes a sidewall integrally formed with the bottom surface, the sidewall including an integrated sidewall feature arranged to provide structural support for the container. The container includes a lid portion. The lid portion including a top surface that includes first integrated top feature co-operating with the integrated bottom feature and the integrated support feature to provide structural support for the container. The lid further includes a second integrated top feature that includes apertures that allow an outflow of air from within the container to the external environment. A hinge assembly integrally formed with a first section of the sidewall for pivotally connecting the base portion to the lid portion includes a first hinge portion integrally formed with the base portion, a second hinge portion integrally formed with the lid portion, and a flexure between first and second hinge portion that allows pivoting of the second hinge portion about the first hinge portion. A locking mechanism that includes a first portion integrally formed with a second section of the sidewall different from the first section, and a second portion integrally formed with a section of the lid portion. The first and second portions of the locking mechanism are co-operatively shaped so that they interlock wherein in a locking configuration, the locking mechanism secures the lid and the base portion.

A method of forming a molded fiber container suitable for containing a food item can be performed by providing a fiber slurry, providing a mold having a shape in the form of the container, conformally applying the fiber slurry to the mold, wherein the conformally applied fiber slurry takes on essentially the shape of the container, curing the fiber slurry, and obtaining the molded fiber container by separating the mold and the cured fiber slurry. In the described embodiment, the molded fiber container includes a base portion, the base portion a bottom surface, the bottom surface including concentric ridges, the concentric ridges providing structural support and elevating an item placed on at least some of the ridges a sidewall integrally formed with the bottom surface, the sidewall including an integrated sidewall feature, the integrated sidewall feature arranged to provide structural support for the container; a lid a plurality of openings arranged in accordance with at least some of the plurality of ridges, and a moisture channeling feature integrally formed in the lid, the moisture channeling feature cooperating with at least some of the plurality of openings and the gap to provide a path by which at least some of the moisture expelled from the food item is transported out of the container and into an external environment.

### BRIEF DESCRIPTION OF THE DRAWINGS

The invention and the advantages thereof may best be understood by reference to the following description taken in conjunction with the accompanying drawings.

FIG. 1 shows representative pizza container in accordance with a described embodiment.

FIG. 2 shows a perspective view of the container in a first open configuration.

FIG. 3 shows a cross sectional view of the container in a closed configuration showing the airflow that is created in expelling the moisture from the container.

FIG. 4 shows a perspective view of the bottom of the container.

FIG. 5 shows a top view of the lid portion of the container.

FIG. 6 shows a flipped view of the container.

FIG. 7 shows a profile view of the container.

FIG. 8 shows a bottom view of two containers in a nested configuration.

FIGS. 9a-9c shows a close up step by step view of the locking mechanism and the associated locking method

FIG. 10 shows a close up perspective view of hinge assembly integrally formed between lid portion and bottom portion.

FIG. 11 shows a perspective view of the container including indicia.

### DETAILED DESCRIPTION OF REPRESENTATIVE EMBODIMENTS

In the following description, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

The embodiments herein describe a cost effective, environmentally friendly container. The container can have an aesthetically pleasing appearance and can also be used to store and transport an item. The shape and size of the container can be widely varied to contain any type of item. For example, the container can be used to contain computer hardware components, office supplies or food items of varying shapes and sizes. The container can also be used to display an item. The container can also be used to contain an item during any preparation or process steps associated with such item. Alternatively, the container can be used to contain and subsequently protect an item incorporated with other items in a bundled shipping configuration. The container can include indicia to convey a message or further add to the aesthetic appeal of the container.

The container can be formed of many types of material. The container can be formed of environmentally friendly materials such as bamboo, Begasse, rice hull, PLA, etc. In a particular embodiment, however, the container can be formed from a single, continuous piece of molded fiber. The use of molded fiber has many advantages. One advantage to using molded fiber is that since molded fiber is derived from recycled paper, molded fiber is considered an environmentally sustainable material. Another advantage to using molded fiber is that molded fiber can be easily formed into any desired shape. Moreover, molded fiber also resists moisture absorption. In this way, any moisture and liquids that are emitted from the item from within the container or present in the area surrounding the container are not generally absorbed into the molded fiber thereby helping the molded fiber container to retain its structural integrity.

The molded fiber container can be formed through any suitable technique including but not limited to the transfer molding process. In the transfer molding process, a fine mesh mold is positioned within a vacuum chamber and fiber slurry containing fiber pulp is then sprayed onto the mold using airflow. The fiber pulp on the mold is then dried ultimately taking on the shape of the mold. In addition to transfer molding the molded fiber container can be created using other molded pulp manufacturing processes. For example, a thick wall molding process can be used to create thicker more rugged containers whereas a thermoformed fiber process can create molded fiber products that are denser and more resistant to the environment.

In a particularly useful embodiment, the molded fiber container can be used to store a food item that can come in any shape and size such as, for example, eggs, fruits, and meat products. Accordingly, the size and shape of the container can be widely varied. For example, the container can have a size that is small enough to contain a single serving of food. On the other hand, the molded fiber container can be fabricated to have a size that is large enough to contain multiple servings of food. Containers of this size are especially useful in situations where food needs to be stored and transported in large quantities, such as at catered events. For the remainder of this discussion, however, and without loss of generality, the container will be discussed in terms of a single item food container. More specifically, the food container can be used to store and transport a hot food product such as pizza. Accordingly, the pizza container can have a size and shape (i.e., circular or rectangular) in accordance with the shape of the pizza contained within.

In order to preserve and enhance the overall culinary experience, the container can be formed to include a number of features that can be integrated into the structure of the container. For example, in order to prevent moisture from being trapped beneath the pizza rendering the pizza soggy, selected portions of an interior surface of a base of the container can be elevated to provide a support platform. In one embodiment, the elevated portion can take the form of concentric rings that elevate the pizza from the bottom surface of the container. Elevating the pizza from the bottom surface ensures that any steam that is emitted from the bottom of the pizza can flow away from the bottom of the pizza. Allowing such steam to flow away from the bottom of the pizza prevents moisture from becoming trapped between the pizza and the bottom surface of the container and subsequently reabsorbed by the pizza causing it to get soggy. The container can also include openings in the lid that allow steam to escape from the pizza. Allowing such steam to escape from within the container further ensuring that the pizza does not become soggy through the re-absorption of moisture.

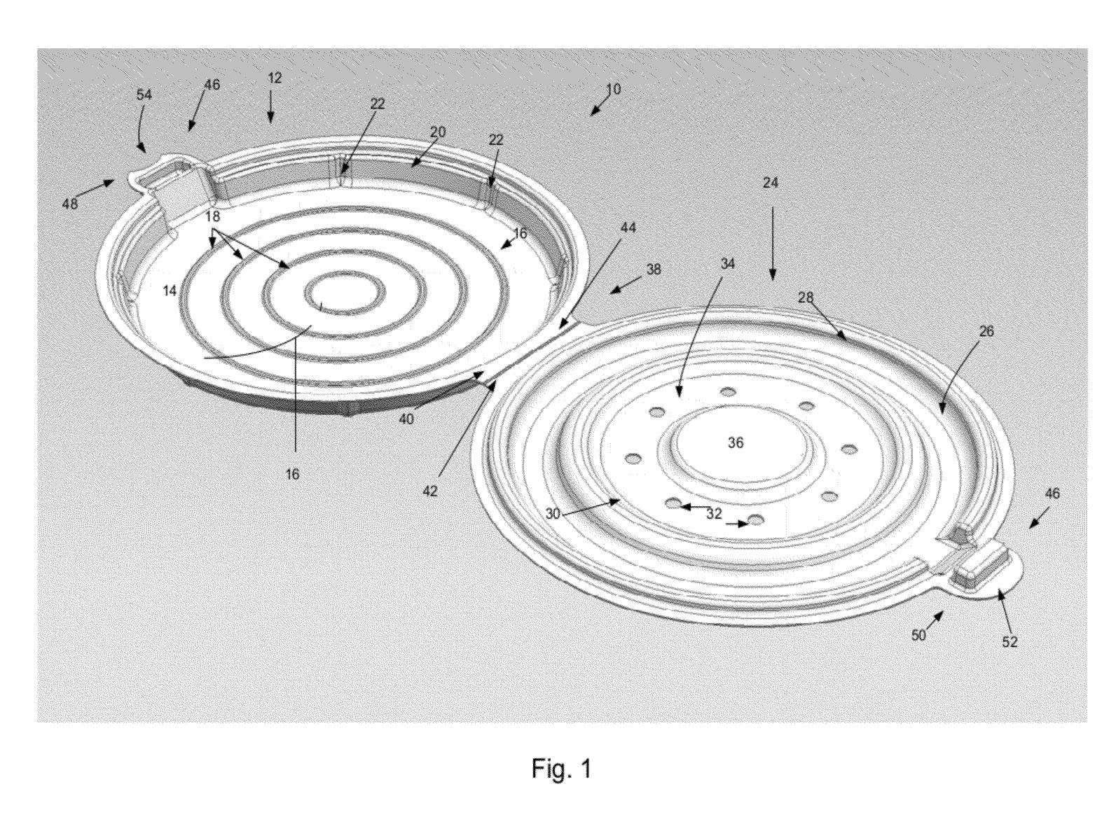

These and other embodiments are discussed below with reference to FIGS. 1-11. However, those skilled in the art will readily appreciate that the detailed description given herein with respect to these figures is for explanatory purposes only and should not be construed as limiting.

FIG. 1 shows representative container 10 in a first open configuration in accordance with a described embodiment. In the particular embodiment shown in FIG. 1, container 10 can be used to enclose and support a hot food item. The hot food item can take the form of a pizza. In those cases, however, where container 10 is formed of heat resistant material, the pizza can be assembled in a preparation area, such as kitchen, placed in container 10, and subsequently placed in a cooker, such as a oven. In this way, the pizza can be assembled, cooked, and as described below, presented for consumption without removing the pizza from container 10.

Container 10 can include base portion 12 having bottom surface 14. Bottom surface 14 can include bottom feature 16 integrated with base portion 12. In the described embodiment, bottom feature 16 can be formed of concentric ridges 18 each extending above bottom surface 14. Ridges 18 can provide structural support for container 10 by distributing an applied load helping to prevent excessive bending and flexing of container 10. In this way, even though fully loaded and in the first open configuration, pizza container 10 can be picked up and transported without undue risk of deforming. Moreover, when a pizza is placed upon ridges 18, an air gap between bottom surface 14 and the pizza can be formed allowing excess moisture to escape from the pizza. The air gap can also act as a thermal barrier preventing excess heat transfer away from the pizza. In this way, while enclosed within pizza container 10, the pizza can remain fresh and crisp and hot for an extended period of time. Base portion 12 can also include sidewalls 20 integrally formed with bottom surface 18. Sidewalls 20 can include integrated sidewall feature 22. Integrated sidewall feature 22 can be recessed into sidewalls 20 having a shape that can help prevent flexing of base portion 12.

Container 10 can also include lid portion 24 having a size and shape in accordance with base portion 12. In this way, in a closed configuration, lid portion 24 and base portion 12 can come together to form an enclosed space well suited for accommodating the pizza. Lid portion 24 can include top surface 26 onto which can be formed first top feature 28 and second top feature 30. In one embodiment, first top feature 28 can be an elevated region integrally formed with lid portion 24 in such a way as to provide structural support for lid portion 24. Furthermore, in a closed configuration, integrated first top feature 28 can align and cooperate with sidewalls 20 and integrated side wall features 22 to provide additional structural support for pizza container 10. In addition to first top feature 28, second top feature 30 can have a raised shape suitable for providing structural support for lid portion 24. In addition to providing structural support for container 10, second top feature 30 can aid in the transport of excess moisture from the pizza through vents 32. In one embodiment, for example, second top feature 30 can form channel 34 that can cooperate with central platform 36 to create a “chimney effect” that can help to draw excess moisture from the pizza that can be channeled to vents 32 for transport to the external environment. In this way, ridges 18, second top feature 30 and vents 32 can work together to form a mechanism by which a proper moisture level within container 10 can be maintained thereby assuring that the pizza does not absorb excess moisture and become soggy.

Base portion 12 and lid portion 24 can be pivotally connected to one another by way of hinge assembly 38. Hinge assembly 38 can be integrally formed with both lid portion 24 and base portion 12. Hinge assembly 38 can include first hinge portion 40 as part of base portion 12 and second hinge portion 42 as part of lid portion 24. Flexure 44 can pivotally connect first hinge portion 40 and second hinge portion 42. First hinge portion 40 and second hinge portion 42 can be formed of stiff molded fiber whereas flexure 44 can be formed of bendable molded fiber. In this way, flexure 44 can facilitate a folding over of first hinge portion 40 and second hinge portion 44 when container 10 transitions to the closed configuration. Alternatively, when transitioning to an open configuration, flexure 44 can facilitate the unfolding of first hinge portion 40 and second hinge portion 42.

Container 10 can also include locking mechanism 46. Locking mechanism 46 can include first portion 48 integrally formed with base portion 12 and second portion 50 integrally formed with lid portion 24. Locking mechanism 46 can be used to secure base portion 12 and lid portion 24 when container 10 is placed in the closed configuration. By securing it is meant that in the locked configuration, locking mechanism 46 can exert a securing force sufficiently strong to prevent base portion 12 and lid portion 24 from separating from each other when, for example, container 10 is being transported. For example, when locking mechanism 46 is engaged, lid portion 24 remains securely attached to base portion 12. However, when a user desires to open pizza container 10 by disengaging locking mechanism 46, lip 52 on second portion 50 can be easily accessed by the user inserting a finger, or other object, within recess portion 54 of first portion 48. Recess portion 54 can be sized and positioned relative to lip 52 to provide easy access to lip 52. In this way, a simple lifting action on lip 52 can easily overcome the securing force provided by locking mechanism 46 to separate lid portion 24 and base portion 12. By overcoming the securing force provided by locking mechanism 46, the user can easily cause container 10 to transition from a closed configuration to an open configuration. It should also be noted that container 10 can be used to dispose of any eating utensils, napkins, cups, and so forth in an environmentally friendly manner. For example, all used eating utensils and other paraphernalia can be placed inside of container 10 when the meal is finished, closed, sealed and disposed of as a single unit making disposal easy and efficient.

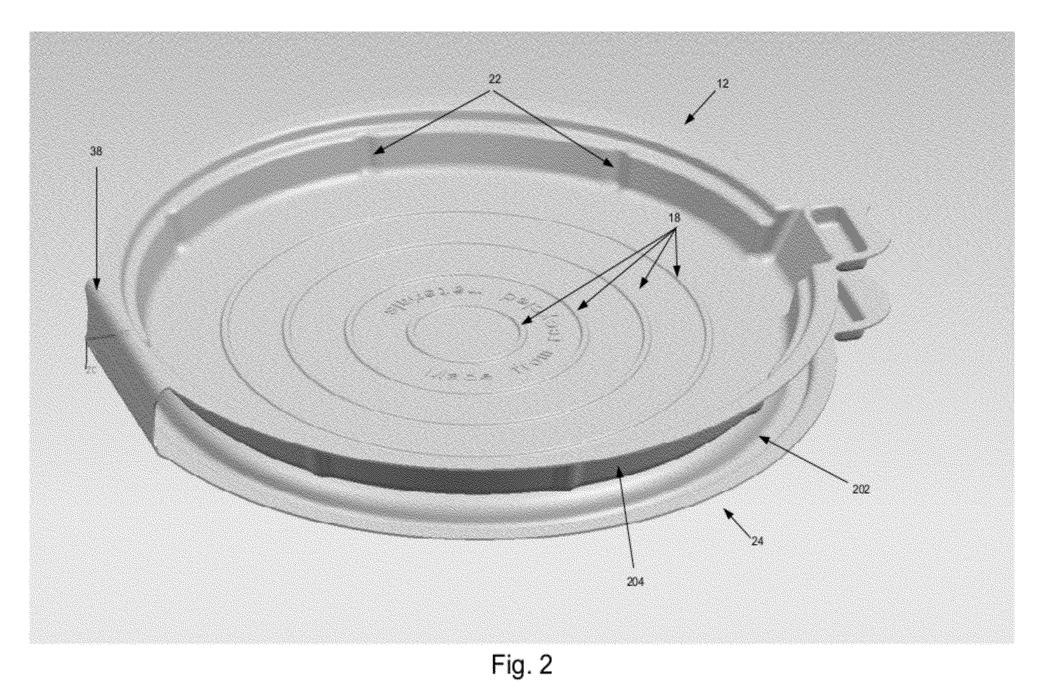

In the first open configuration, lid portion 24 and base portion 12 are positioned approximately 180° relative to each other such that any item (such as the pizza) on bottom surface 14 is easily viewed and accessible. However, in some situations, it may not be convenient to place container 10 in the first open configuration due to the large footprint presented by the relative positioning of base portion 12 and lid portion 24. For example, if available space is limited due to, for example, a small dining table or area, it may not be convenient or even possible to position base portion 12 and lid portion 24 in the first open configuration. Accordingly, one of the advantages provided by container 10 is the ability of container 10 to be placed in a second open configuration, also referred to in some embodiments as a food server configuration. As shown in FIG. 2, in the second open configuration, container 10 exhibits a much smaller footprint than that presented by the first open configuration since instead of being rotated about 180° with respect to each other as in the first open configuration, lid portion 24 and base portion 12 are rotated about each other approximately 360°. In this way, exterior surface 202 of lid portion 24 and exterior surface 204 of base portion 12 can be placed in at least partial direct contact with each other in such a way as to permit lid portion 24 to act as a support surface along the lines of a pedestal and provide full support for base portion 12. In this way, container 10 can provide an cost effective and environmentally friendly mechanism for storing, transporting, and even presenting and serving the food item. Moreover, the various freshness keeping features of container 10 can help to keep the food item fresh and hot and crispy (in the case of at least a pizza) until the time to open lid portion 24 and presenting the food item for consumption. Moreover, lid portion 24 as the pedestal also has the added advantage of eliminating the potential for any heat caused damage of any surfaces upon which container 10 is placed.

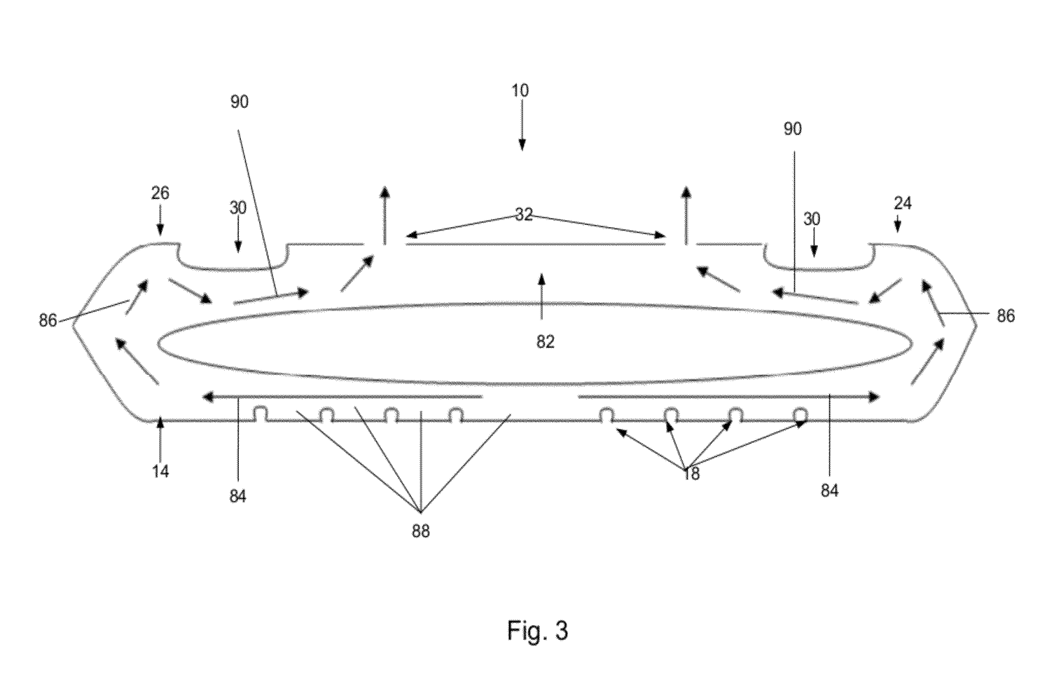

FIG. 3 shows a cross sectional view of container 10 and the resulting airflow that can create an integrated container moisture expelling process. Specifically, ridges 18 can elevate contained pizza 82 away from bottom surface 14 of base portion 12 of container 10. Elevating pizza 82 away from bottom surface 14 can create gaps 88 between pizza 82 and bottom surface 14. Gaps 88 can allow for the creation of bottom airflow 84 between the bottom of pizza 82 and bottom surface 14, thereby carrying hot air that is emitted from the bottom of pizza 82. Bottom airflow 84 can flow out from underneath pizza 82 forming convective airflow 86 that transports the hot air from bottom airflow 84 and can flow upward following the contours of the sides of container 10. Side airflow 86 continues along the contours of the sides of the container and becomes top surface airflow 90 along top surface 26 of lid portion 24.

Top feature 30 integrated within lid portion 24 increases the surface area along exterior surface of lid portion 24, thereby serving to create a lower outside pressure along the exterior surface. Top surface airflow 90 can have a higher pressure than the outside pressure along the exterior surface of lid portion 24, thereby creating a chimney effect. Such chimney effect causes top surface airflow 90 to move along top surface 26, whereby airflow can subsequently exit container 10 through vents 32. Vents 32 can be formed within top surface 26 and extend through lid portion 24. Vents 32 can be positioned in an annular pattern concentric with the center of lid portion 24, helping to ensure that a maximum amount of contained hot air, including air from bottom airflow 84, can exit container 10. In turn, such moisture air expelling process ensures that the hot air that is generated from pizza 82 can be discharged from within container 10. Expelling the hot air generated by pizza 82, prevents pizza 82 from reabsorbing the moisture within such hot air and subsequently becoming soggy.

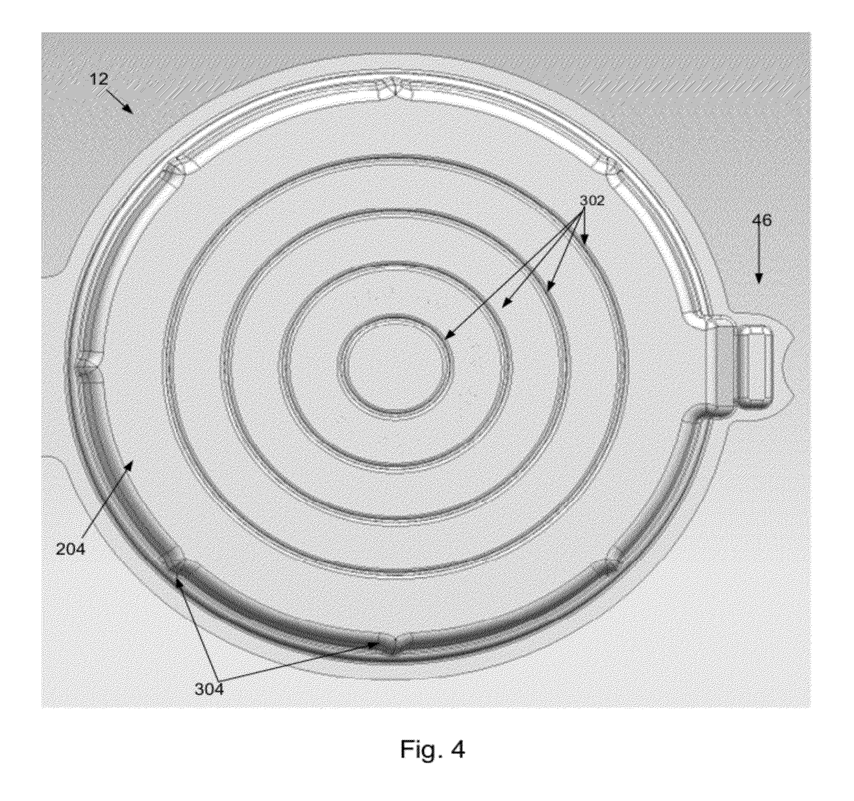

FIG. 4 shows an expanded perspective view of the exterior of base portion 12 in accordance with a described embodiment. Base portion 12 can include exterior surface 204. Exterior surface 204 can include concentric recesses 302 that correspond to concentric ridges 18 which extend out from the bottom surface 14 of base portion 12. Exterior surface 204 can also include integrated sidewall feature protrusions 304 that correspond to integrated sidewall features 22 that are recessed in sidewalls 20. Sidewall feature protrusions 304 and concentric recesses 302 are formed along exterior surface 204 of base portion 12 through the fiber molding process. For example, concentric ridges 18 are formed through equivalently shaped ridges within the mold pattern, such that the deposited fiber slurry of a desired thickness level forms in the shape of such ridges. When the resulting molded fiber container is lifted away from the mold, concentric recesses 302 are left within exterior surface 204, where the fiber slurry formed on top of the ridges in the mold pattern. Concentric recesses 302 and sidewall feature protrusions 304 can further increase the structural stability of the container when it is used to contain and transport an item. Specifically, concentric recesses 302 and sidewall feature protrusions 304 can limit the torsional flexing of the base portion 12.

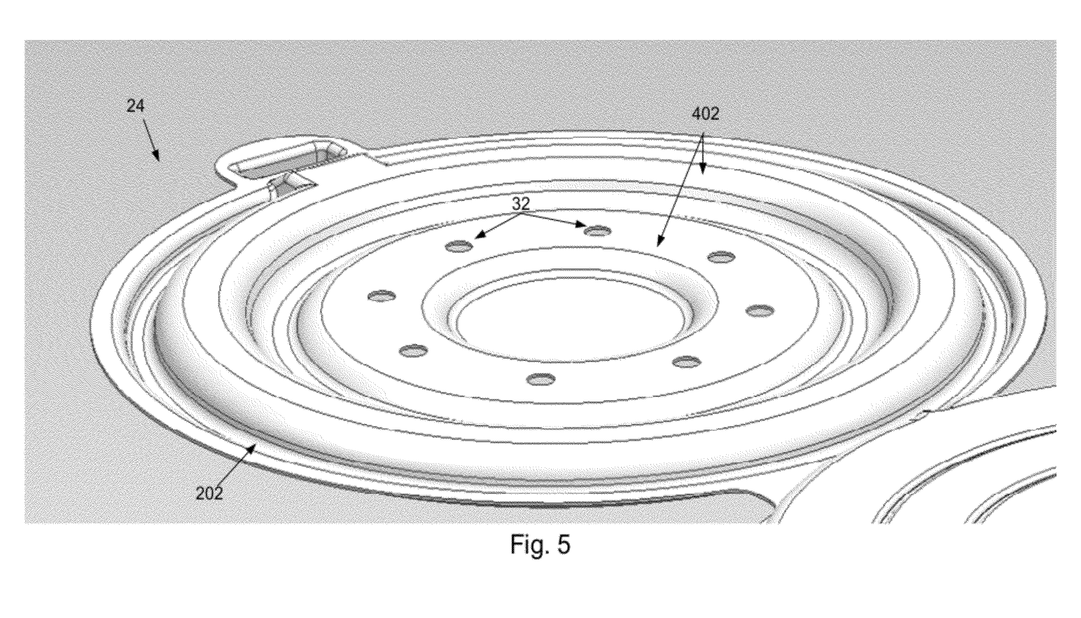

FIG. 5 shows an enhanced perspective view of the exterior of lid portion 24 of the container in a closed configuration. In the closed configuration, lid portion 24 can be displaced so that it substantially covers the container volume formed within base portion 12. Vents 32 extend from the contained area through lid portion 24 creating openings within lid portion exterior surface 202. Vents 32 serve to create passageways, through which excess moisture can flow out of the container. Lid exterior surface 202 can also include the corresponding exterior surface profiles 402 of the first and second top features of lid portion 24. Specifically, just as sidewall feature protrusions 304 and concentric recesses 302 can be formed through the fiber molding process in the exterior surface 204 of base portion 12, the first and second top features of lid portion 24, can also create exterior integrated surface profile features 402 of lid portion 24. Such surface profiles 402 are corresponding negative features of the first and second top features of lid portion 24. Exterior integrated surface profile features 402 are not only a product of the molding fabrication process, but also they can serve to further add structural stability to the container by limiting torsional flexing of lid portion 24.

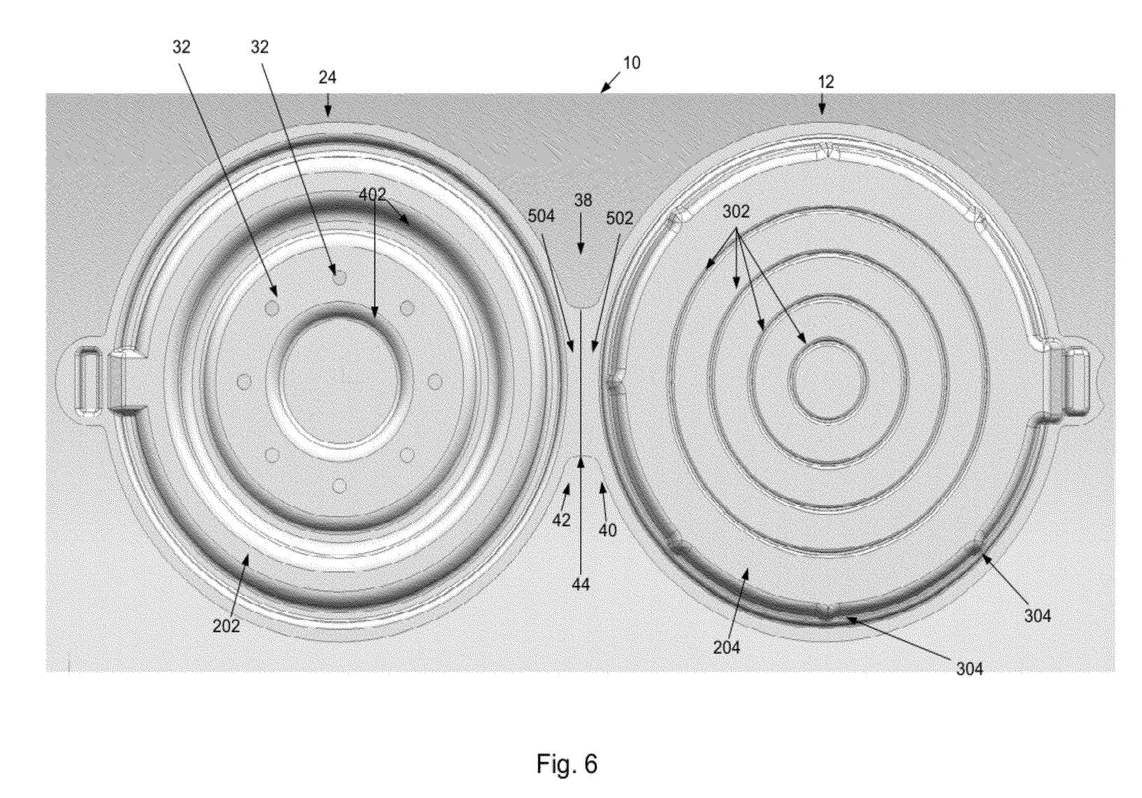

FIG. 6 shows a flipped over view of container 10 showing more clearly exterior surfaces 202 and 204. Exterior bottom surface 204 can include concentric recesses 302 and sidewall feature protrusions 304. Exterior lid surface 202 can include exterior integrated surface profile features 402 and openings created by vents 32. Lid portion 24 can be coupled to base portion 12 through hinge assembly 38. Hinge assembly 38 can include first hinge portion exterior surface 502 and second hinge portion exterior surface 504. Hinge portions 502 and 504 are connected through flexure 44 that facilitates the pivoting of lid portion 24 about base portion 12. Such flexure allows for the folding over of the first hinge portion 40 with the second hinge portion 42, such that when the container is in the second open configuration first hinge portion exterior surface 502 makes substantial direct contact with second hinge portion exterior surface 504.

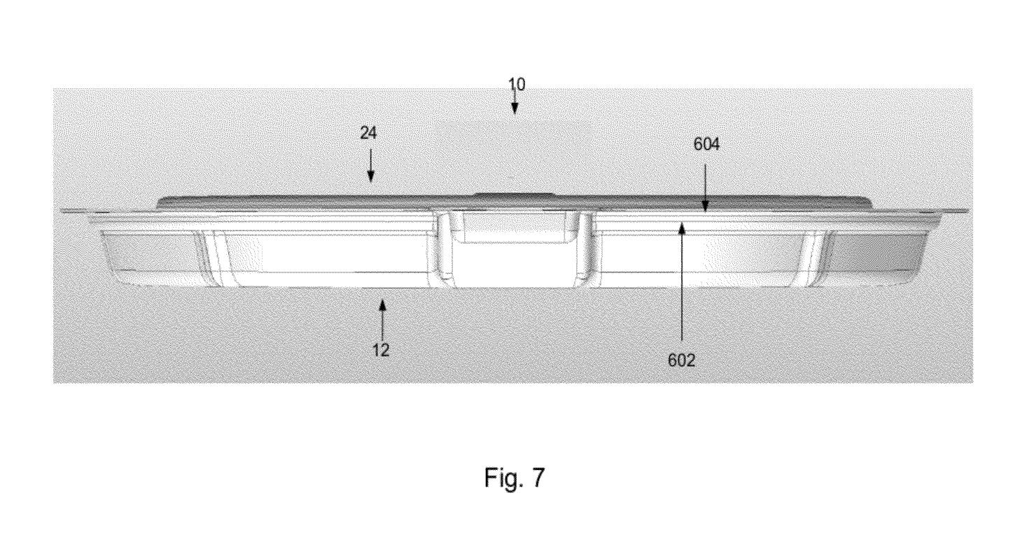

FIG. 7 shows a profile view of container 10 in the closed configuration highlighting the close fit tolerance between base portion 12 and lid portion 24. In this way, the unity of design presented by container 10 adds to both form and function. For example, the close fit tolerance of container 10 provides a clean and uniform appearance that enhances the overall aesthetic experience of the user. In this way, a purveyor of pizza, for example, can store, deliver, and present a product that appeals not only to the purchaser's pallet but also to the purchaser's taste and aesthetic appreciation. The unity of design presented by container 10 also can serve to ensure that the item remains completely contained within container 10 throughout storage, delivery and any other previously mentioned functioning embodiments of container 10. The close fit tolerance between base portion 12 and lid portion 24 can be further enhanced by the use of bottom portion lip 602 and lid portion lip 604 that extend out along the peripheral edges of corresponding base and lid portions 12 and 24. Lips 602 and 604 can come into substantial direct contact with each when container 10 is in a closed configuration. Such contact further ensuring that the item remains contained within container 10 while in a closed configuration.

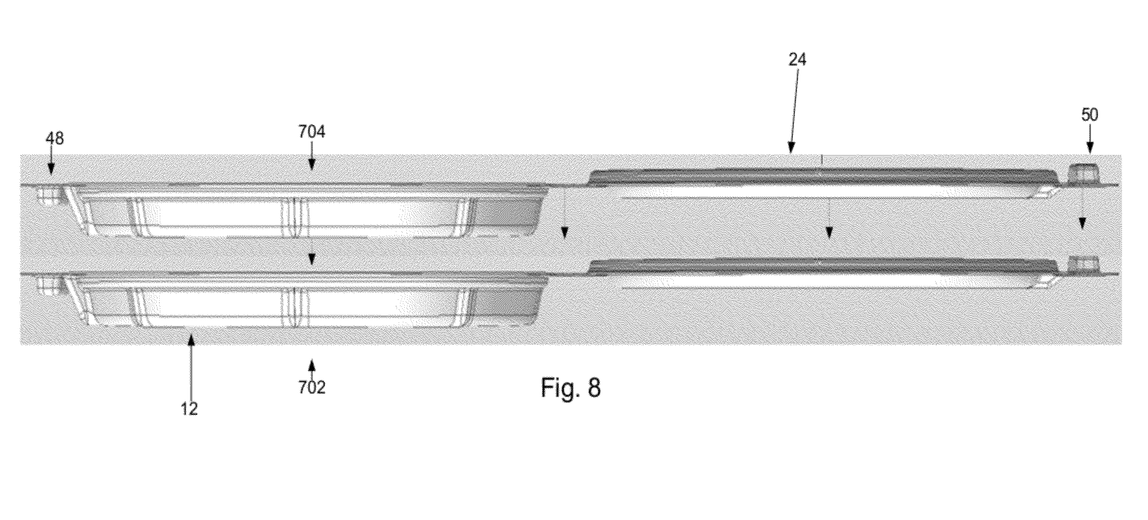

FIG. 8 shows a profile view of two containers 702 and 704 in a nested stack configuration. The nested stack configuration is advantageous in that it allows for the convenient storage of multiple containers 10 in a small space. Such configuration is particularly useful in pizza restaurants, where space is limited, and empty boxes must still be easily accessible. The nested stack configuration can be realized when lid portion 24 and base portion 12 are substantially 180° while in the previously mentioned first open configuration. The sidewalls 20 of the base portion 12 can be tapered so that sidewalls 20 encompass a greater area at the top than at the bottom. The tapering of sidewalls 20 ensures that base portion 12 can receive the corresponding base portion 12 of second container 704. In such nested configuration, the exterior bottom surface of the second container can make substantial contact with bottom surface 14 and sidewalls 20 of base portion 12 of first container 702. Furthermore, locking mechanism 46 and lid portion 24 can be nestable such that the lid portion 24 and locking mechanism 46 of second container 704 fits within the lid portion 24 and the locking mechanism 46 of first container 702. Specifically, lid locking mechanism first portion 48 of second container 704 can fit within lid locking mechanism first portion 48 of first container 702 while lid locking mechanism second portion 50 of second container 704 can fit within lid locking mechanism second portion 50 of first container 702.

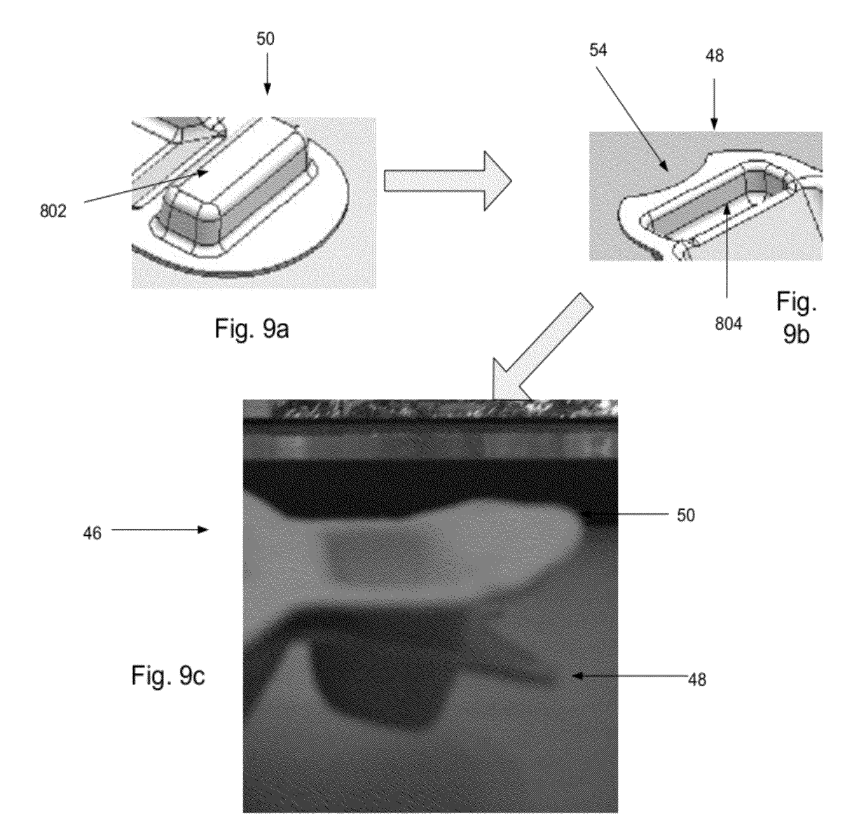

FIGS. 9a-9c shows a close up step by step view of the locking mechanism 46 and the associated locking method. Locking mechanism 46 can be a press fit lock with first portion 48 that is integrally formed with base portion 12 and second portion 50 that is integrally formed with lid portion 24. Second portion 50 can include protrusion 802 that extends out from second portion 50. First portion 48 can include cavity 804 that is integrally formed within first portion 50. Cavity 804 can receive protrusion 802 when an external force pushes first portion 48 and second portion 50 together while container 10 is in a closed configuration. In receiving protrusion 802, cavity 804 generates a locking mechanism force, which serves to hold locking mechanism 46 and subsequently lid portion 24 and base portion 12 in closed configuration. Such locking mechanism force resists external forces applied to container 10, so that container 10 remains closed, throughout storage, transportation, and any other functioning of container 10. Locking mechanism 46 can include recessed portion 54 within first portion 48, which allows the user to contact second portion 50 such that the second portion 50 can be separated from the first portion 48.

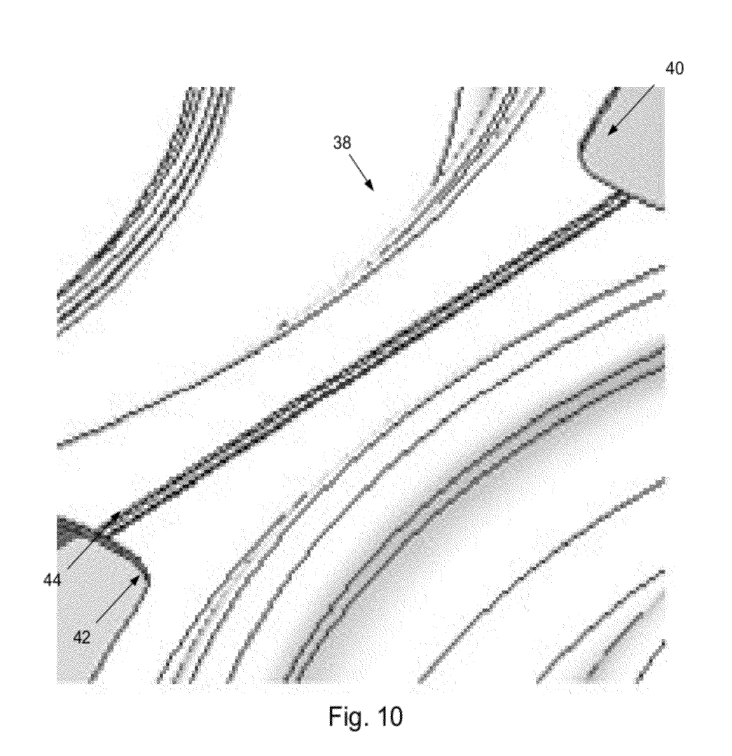

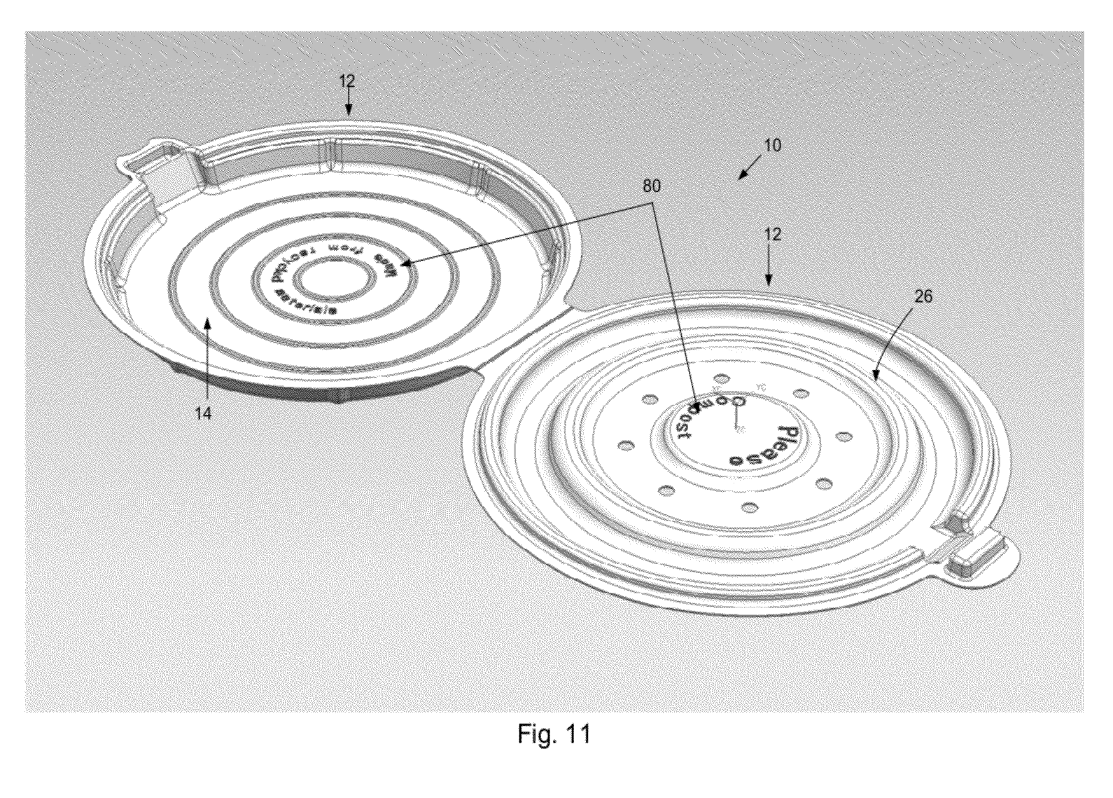

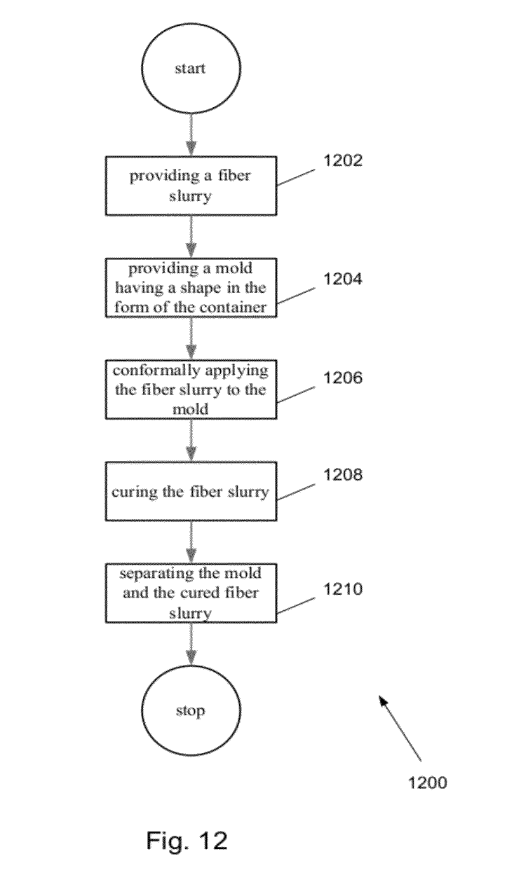

FIG. 10 shows a close up perspective view of hinge assembly 38 integrally formed between lid portion 24 and base portion 12. Hinge assembly 38 can include first hinge portion 40 and second hinge portion 42. First hinge portion 40 is integrated with base portion 12 while second hinge portion 42 is integrated with lid portion 24. First hinge portion 40 is coupled to second hinge portion 42 through a flexure 44. Flexure 44 facilitates the transitioning between first and second open and closed configurations by allowing for the folding of second hinge portion 42 and associated lid portion 24 over second hinge portion 42.

Container 10 can also include indicia 80 as shown in FIG. 11. Indicia 80 can be formed through any suitable means, including but not limited to embossing. Indicia 80 can be in any shape to convey any message. For example, as shown, indicia 80 can state “made from recycled material” or “please compost.” Specifically, indicia 80 can be used to convey to the user that the container is made from environmentally friendly material. Indicia 80 can be placed on any suitable surface of container 10, including but not limited to bottom surface 14 of base portion 12 or top surface 26 of lid 12.

FIG. 12 shows a flowchart detailing process 1200 for forming a molded fiber container in accordance with the described embodiments. Process 1200 can be performed by providing a fiber slurry at 1202, providing a mold having a shape in the form of the container at 1204, conformally applying the fiber slurry to the mold at 1206, where the conformally applied fiber slurry takes on essentially the shape of the container, curing the fiber slurry at 1208, and obtaining the molded fiber container by separating the mold and the cured fiber slurry at 1210. In one implementation, the molded fiber container can include at least a base portion, the base portion having a bottom surface that includes concentric ridges that provide structural support and elevate an item placed on at least some of the ridges and a sidewall integrally formed with the bottom surface, the sidewall including an integrated sidewall feature, the integrated sidewall feature arranged to provide structural support for the container. The container also includes a lid that includes a plurality of openings arranged in accordance with at least some of the plurality of ridges, and a moisture channeling feature integrally formed in the lid, the moisture channeling feature cooperating with at least some of the plurality of openings and the gap to provide a path by which at least some of the moisture expelled from the food item is transported out of the container and into an external environment.

In a specific embodiment, the container can be reusable. Specifically, the container can be reused in the containment of an item in any of the previously mentioned applications. The reuse of the container is environmentally friendly as it reduces the amount of materials that are consumed by society through the construction of single use containers. Furthermore, the ability to reuse containers reduces the amount of waste that is generated by single use containers. In a further specific embodiment, the container can be formed of material that allows the container to be washed or cleaned before such subsequent reuse.

The various aspects, embodiments, implementations or features of the described embodiments can be used separately or in any combination. The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated.

1. A molded fiber container suitable for containing a food item, comprising:
a base, the base comprising:
a plurality of ridges integrated with an interior surface of the base, wherein when the food item is placed on at least some of the plurality of ridges, a gap is formed between the food item and the interior surface of the base, the gap assisting in thermally isolating the food item and allowing moisture expelled from the food item to be transported away from the food item; and
a lid, the lid comprising:
a plurality of openings arranged in accordance with at least some of the plurality of ridges, and
a moisture channeling feature integrally formed in the lid, the moisture channeling feature cooperating with at least some of the plurality of openings and the gap to provide a path by which at least some of the moisture expelled from the food item is transported out of the container and into an external environment.

2. The molded fiber food container as recited in claim 1, further comprising:
a hinge assembly integrally formed with the molded fiber container, the hinge assembly pivotally connecting the base and the lid.

3. The molded fiber food container as recited in claim 2, wherein in a food server configuration, the lid is rotated about the hinge assembly to an inverted position and about 360° rotation relative to the base such that at least a portion of an exterior surface of the lid is in direct contact with at least a portion of an exterior surface of the base, the lid providing full support for the base and the food item.

4. The molded fiber food container as recited in claim 3, wherein in the food server configuration, the inverted lid is placed on a supporting surface, the inverted lid supporting the base.

5. The molded fiber food container as recited in claim 3, wherein in the food server configuration, the food item is fully presented and accessible.

6. The molded fiber food container as recited in claim 4, wherein in the food server configuration, the food container is a reduced footprint food serving apparatus.

7. The molded fiber container as recited in claim 1, wherein at least some of the plurality of ridges are concentric and circular.

8. A container, comprising:
a base portion, the base portion comprising:
a bottom surface, the bottom surface including concentric ridges, the concentric ridges providing structural support and elevating an item placed on at least some of the ridges, and,
a sidewall integrally formed with the bottom surface, the sidewall including an integrated sidewall feature, the integrated sidewall feature arranged to provide structural support for the container;
a lid portion, comprising a top surface:
the top surface comprising:
a first integrated top feature co-operating with the integrated bottom feature and the integrated side feature to provide structural support for the container, and
a second integrated top feature that includes a plurality of apertures that allow for the outflow of air from within the container;
a hinge assembly integrally formed with a first section of the sidewall for pivotally connecting the base portion and the lid portion, the hinge assembly comprising:
a first hinge portion integrally formed with the base portion,
a second hinge portion integrally formed with the lid portion,
a flexure between first and second hinge portion, the flexure allowing for the pivoting of the second hinge portion about the first hinge portion; and,
a locking mechanism comprising:
a first portion integrally formed with a second section of the sidewall different from the first section, and
a second portion integrally formed with a section of the lid portion, wherein the first and second portions of the locking mechanism are co-operatively shaped so that they interlock wherein in a locking configuration, the locking mechanism secure.

9. The container as recited in claim 8, wherein the container is used to contain a food item.

10. The container as recited in claim 8, wherein the container is fabricated from a molded fiber.

11. The container as recited in claim 8, wherein the container is fabricated from environmentally friendly materials including bamboo, Begrass, rice hull, and PLA.

12. The container as recited in claim 8, wherein in a second open configuration, the second hinge portion is pivoted with respect to the first hinge portion, such that a portion of the exterior surface of the lid makes contact with a portion of the exterior surface of the base.

13. The container as recited in claim 8, wherein in a first open configuration, the second hinge portion is pivoted with respect to the first hinge portion, such that the angle between the first and second hinge portions is substantially 180°.

14. The container as recited in claim 8, wherein in a closed configuration, the second hinge portion is pivoted with respect to the first hinge position, such that the lid portion makes contact with the sidewalls of the base portion.

15. The container as recited in claim 12, wherein the container is used in the second open configuration to display a contained item in a manner with a reduced footprint.

16. The container as recited in claim 13, further including at least a second container, wherein at least the first and second containers are stacked together in a nested configuration.

17. A method of forming a molded fiber container suitable for containing a food item, comprising:
providing a fiber slurry;
providing a mold having a shape in the form of the container;
conformally applying the fiber slurry to the mold, wherein the conformally applied fiber slurry takes on essentially the shape of the container;
curing the fiber slurry; and
obtaining the molded fiber container by separating the mold and the cured fiber slurry, wherein the molded fiber container comprises:
a base portion, the base portion comprising:
a bottom surface, the bottom surface including concentric ridges, the concentric ridges providing structural support and elevating an item placed on at least some of the ridges, and,
a sidewall integrally formed with the bottom surface, the sidewall including an integrated sidewall feature, the integrated sidewall feature arranged to provide structural support for the container;
a lid, the lid comprising:
a plurality of openings arranged in accordance with at least some of the plurality of ridges, and
a moisture channeling feature integrally formed in the lid, the moisture channeling feature cooperating with at least some of the plurality of openings and the gap to provide a path by which at least some of the moisture expelled from the food item is transported out of the container and into an external environment.

18. The method as recited in claim 17, wherein the molded fiber container further comprises:
a hinge assembly integrally formed with the molded fiber container, the hinge assembly pivotally connecting the base and the lid.

19. The method as recited in claim 18, wherein in a food server configuration, the lid is rotated about the hinge assembly to an inverted position and about 360° rotation relative to the base such that at least a portion of an exterior surface of the lid is in direct contact with at least a portion of an exterior surface of the base, the lid providing full support for the base and the food item.

20. The method as recited in claim 19, wherein in the food server configuration, the inverted lid is placed on a supporting surface, the inverted lid supporting the base.

21. The method as recited in claim 20, wherein in the food server configuration, the food item is fully presented and accessible.

22. The method as recited in claim 21, wherein in the food server configuration, the food container is a reduced footprint food serving apparatus.

23. The method as recited as recited in claim 18, wherein at least some of the plurality of ridges are concentric and circular.
